(19) United States
(12) Patent Application Publication
(10) Pub. No.: US 2015/0323880 A1
(43) Pub. Date: Nov. 12, 2015

(54) IMAGE FORMING APPARATUS

(71) Applicant: CANON KABUSHIKI KAISHA, Tokyo (JP)

(72) Inventor: Yasuo Kamei, Tokyo (JP)

(21) Appl. No.: 14/701,280

(22) Filed: Apr. 30, 2015

(30) Foreign Application Priority Data
May 7, 2014 (JP) 2014-095909

(51) Int. Cl. G03G 15/00

(52) U.S. Cl. CPC G03G 15/043

(57) ABSTRACT

An image forming apparatus, including: a rotatable photosensitive member; a light source configured to emit a light beam; a rotary polygon mirror configured to deflect the light beam so that the light beam emitted from the light source scans a surface of the photosensitive member; a motor configured to rotate the rotary polygon mirror; a first signal generating unit configured to detect a rotation amount of the rotary polygon mirror to generate a first signal; and a second signal generating unit configured to detect a rotation amount of the photosensitive member to generate a second signal, wherein a rotation amount of the motor is controlled based on the first signal and the second signal so that the first signal is synchronized with the second signal.

### BACKGROUND OF THE INVENTION

1. Field of the Invention

The present invention relates to an image forming apparatus including a rotatable photosensitive member and a rotary polygon mirror.

2. Description of the Related Art

In a color image forming apparatus configured to form a color image (hereinafter referred to as “image forming apparatus”), a photosensitive drum configured to bear a toner image (hereinafter referred to as “photosensitive member”) is required to be driven so that a surface speed of the photosensitive member becomes a constant speed. When the surface speed of the photosensitive member fluctuates, an exposure position on a surface of the photosensitive member, which is to be exposed to a light beam, is displaced from a position originally required to be exposed. In view of the above, rotation of the photosensitive member is controlled so that the surface speed of the photosensitive member becomes a constant speed. However, the surface speed of the photosensitive member may be fluctuated due to a speed fluctuation of a motor configured to drive the photosensitive member, decentering of the photosensitive member, pitch unevenness of gears, shock of entry of a transfer sheet conveyed to the photosensitive member, or the like.

When the surface speed of the photosensitive member is higher than a target speed, a cumulative exposure light amount per unit area is decreased so that developing contrast becomes smaller, with the result that image density is decreased. The developing contrast herein indicates a difference between a surface potential of the photosensitive member exposed to the light beam and a developing bias voltage applied to a developing roller. In addition, the light beam scans the surface of the photosensitive member at a position on a downstream side with respect to the position originally required to be exposed in a sub-scanning direction, and hence a position of an image is displaced toward the downstream side. On the other hand, when the surface speed of the photosensitive member is lower than the target speed, the cumulative exposure light amount per unit area is increased so that the developing contrast becomes larger, with the result that the image density is increased. In addition, the light beam scans the surface of the photosensitive member at a position on an upstream side with respect to the position originally required to be exposed in the sub-scanning direction, and hence the position of the image is displaced toward the upstream side.

That is, the fluctuation of the surface speed of the photosensitive member not only causes unevenness of the developing contrast (unevenness of the image density), but also causes unevenness in pixel density in the sub-scanning direction. The unevenness of the developing contrast and the unevenness in pixel density cause an image failure such as banding (periodic strip-shaped unevenness in density) or color misregistration (positional displacement between colors superimposed on each other). In view of the above, Japanese Patent Application Laid-Open No. H10-3188 proposes a technology of changing a rotation speed of a rotary polygon mirror in accordance with a periodic fluctuation of a rotation speed of the photosensitive member.

However, even in a case where the rotation speed of the rotary polygon mirror is changed in accordance with the fluctuation in the rotation speed of the photosensitive member, when such a momentary fluctuation as shown in FIG. 11 occurs in the rotation speed of the photosensitive member, the change in the rotation speed of the rotary polygon mirror sometimes fails to follow a momentary fluctuation in the rotation speed of the photosensitive member. In such a case, the rotation speed of the rotary polygon mirror temporarily becomes lower than the rotation speed of the photosensitive member. Due to the temporarily lowered speed, the exposure position on the surface of the photosensitive member is displaced from a target position, which is originally required to be exposed, toward the downstream direction. After that, even when the rotation speed of the rotary polygon mirror is changed in accordance with the rotation speed of the photosensitive member, the actual exposure position on the surface of the photosensitive member keeps being displaced from the target position as illustrated in FIG. 12. In a color image forming apparatus, the displacement of the exposure position on the photosensitive member raises a problem in that the color misregistration of the images of a plurality of colors to be overlaid one on another.

### SUMMARY OF THE INVENTION

Therefore, the present invention provides an image forming apparatus which scans a suitable position on a surface of a photosensitive member with a light beam.

In order to solve the above-mentioned problem, there is provided an image forming apparatus, comprising:

a rotatable photosensitive member;

a light source configured to emit a light beam;

a rotary polygon mirror configured to deflect the light beam so that the light beam emitted from the light source scans a surface of the photosensitive member;

a motor configured to rotate the rotary polygon mirror;

a first signal generating unit configured to detect a rotation amount of the rotary polygon mirror to generate a first signal; and

a second signal generating unit configured to detect a rotation amount of the photosensitive member to generate a second signal,

wherein a rotation amount of the motor is controlled based on the first signal and the second signal so that the first signal is synchronized with the second signal.

Further features of the present invention will become apparent from the following description of exemplary embodiments with reference to the attached drawings.

### BRIEF DESCRIPTION OF THE DRAWINGS

FIG. 1 is a sectional view of an image forming apparatus.

FIG. 2 is a diagram illustrating a drive mechanism of a photosensitive member.

FIG. 3 is a block diagram illustrating a configuration of a light scanning device.

FIG. 4 is a flowchart illustrating image forming operation control of a CPU.

FIGS. 5A and 5B are explanatory diagrams of distance synchronizing exposure control.

FIGS. 6A and 6B are diagrams illustrating a relationship between a BD signal and an encoder signal in the distance synchronizing exposure control.

FIGS. 7A and 7B are explanatory diagrams of a generation method for a control signal of a motor at times of acceleration and deceleration of the photosensitive member.

FIG. 8 is a flowchart illustrating an operation for generating an acceleration/deceleration signal for controlling the motor.

FIG. 9 is a timing chart of illustrating initial phase adjustment according to a third embodiment of the present invention.

FIG. 10 is a diagram illustrating initial phase adjustment according to a fourth embodiment of the present invention.

FIG. 11 is a graph showing a momentary speed fluctuation caused in a rotation speed of the photosensitive member.

FIG. 12 is a diagram illustrating an actual exposure position on a surface of the photosensitive member and a target position.

### DESCRIPTION OF THE EMBODIMENTS

Now, embodiments of the present invention will be described with reference to the drawings.

### First Embodiment

### Image Forming Apparatus

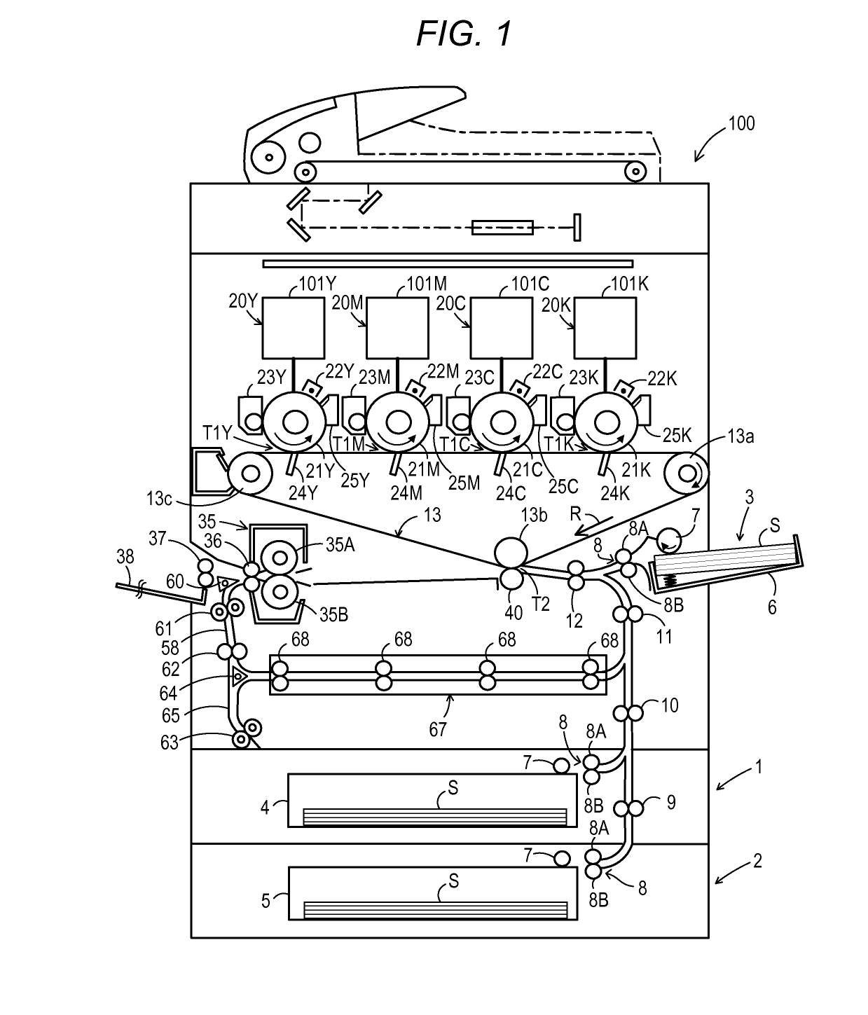

FIG. 1 is a sectional view of an image forming apparatus 100. The image forming apparatus 100 includes a plurality of image forming portions 20 (20Y, 20M, 20C, and 20K). The image forming portion 20Y is configured to form a yellow image using yellow toner. The image forming portion 20M is configured to form a magenta image using magenta toner. The image forming portion 20C is configured to form a cyan image using cyan toner. The image forming portion 20K is configured to form a black image using black toner. The four image forming portions 20 have the same structure except for the colors of the developer (toner), and hence, in the following description, the suffixes Y, M, C, and K are omitted from reference symbols unless otherwise necessary.

The image forming portions 20 include rotatable photosensitive drums 21 serving as image bearing members (hereinafter referred to as “photosensitive members”), respectively. Around the photosensitive members 21, there are arranged charging devices 22, light scanning devices 101, developing devices 23, primary transfer devices 24, and drum cleaning devices 25, respectively. An intermediate transfer belt (endless belt) 13 serving as an intermediate transfer member is arranged below the photosensitive members 21.

The rotatable intermediate transfer belt (image bearing member) 13 is stretched around a drive roller 13a, a secondary transfer opposed roller 13b, and a tension roller 13c. The intermediate transfer belt 13 rotates in a clockwise direction indicated by the arrow R of FIG. 1 (hereinafter referred to as “rotation direction R”) at the time of image formation. Along the rotation direction R of the intermediate transfer belt 13, the yellow image forming portion 20Y, the magenta image forming portion 20M, the cyan image forming portion 20C, and the black image forming portion 20K are arranged in the stated order.

The primary transfer devices 24 are disposed opposite to the photosensitive members 21 across the intermediate transfer belt 13, respectively. The primary transfer device 24 forms a primary transfer portion T1 between the intermediate transfer belt 13 and the photosensitive member 21. A secondary transfer roller 40 is disposed opposite to the secondary transfer opposed roller 13b across the intermediate transfer belt 13. The secondary transfer roller 40 forms a secondary transfer portion T2 between the intermediate transfer belt 13 and the secondary transfer roller 40.

A fixing device 35 is arranged on a downstream side with respect to the secondary transfer portion T2 in a conveyance direction of a transfer sheet (hereinafter referred to as “recording medium”) S. The fixing device 35 includes a fixing roller 35A and a pressure roller 35B, and a nip is formed between the fixing roller 35A and the pressure roller 35B.

The image forming apparatus 100 includes two cassette sheet-feeding portions 1 and 2 and one manual sheet-feeding portion 3. The recording medium S is fed selectively from the sheet-feeding portion 1, 2, or 3. The recording media S are stacked on each of a cassette 4 of the sheet-feeding portion 1, a cassette 5 of the sheet-feeding portion 2, and a tray 6 of the sheet-feeding portion 3. The recording media S are fed by a pick-up roller 7 in an order from an uppermost sheet.

The recording media S, which are fed by the pick-up roller 7, are separated one by one by a separation roller pair 8 including a feed roller 8A serving as a conveyance member and a retard roller 8B serving as a separation member, and thus each separated recording medium S is fed to a registration roller pair 12 in a rotation stopped state. The recording medium S, which is fed from the cassette 4, is conveyed to the registration roller pair 12 through a conveyance route by a plurality of conveyance roller pairs 10 and 11. The recording medium S, which is fed from the cassette 5, is conveyed to the registration roller pair 12 through the conveyance route by a plurality of conveyance roller pairs 9, 10, and 11. A leading edge portion of the recording medium S, which is conveyed to the registration roller pair 12, strikes against a nip of the registration roller pair 12, and thus the recording medium S forms a loop to be temporarily stopped. When a loop is formed in the recording medium S, skew of the recording medium S is corrected.

(Image Forming Process)

Next, an image forming process of the image forming apparatus 100 will be described. The image forming processes of the four image forming portions 20 are the same, and hence the image forming process of the yellow image forming portion 20Y will be described. A part of description of the image forming processes of the magenta image forming portion 20M, the cyan image forming portion 20C, and the black image forming portion 20K is omitted.

The charging device 22Y uniformly charges a surface of the photosensitive member 21Y. The light scanning device 101Y irradiates the uniformly charged surface of the photosensitive member 21Y with laser light (hereinafter referred to as “light beam”) LY modulated in accordance with image information for yellow, to thereby form an electrostatic latent image on the photosensitive member 21Y. The developing device 23Y develops the electrostatic latent image with the yellow toner (developer) into a yellow toner image. The primary transfer device 24Y primarily transfers the yellow toner image, which is formed on the photosensitive member 21Y, onto the intermediate transfer belt 13 in the primary transfer portion T1Y. The yellow toner, which remains on the photosensitive member 21Y after the primary transfer, is removed by the drum cleaning device 25Y, and the photosensitive member 21Y prepares for a next image formation.

After a predetermined time period has elapsed since the start of scanning the photosensitive member 21Y with the light beam LY, the light scanning device 101M starts scanning the photosensitive member 21M with a light beam LM modulated in accordance with image information for magenta, to thereby form an electrostatic latent image on the photosensitive member 21M. The electrostatic latent image is developed with the magenta toner into a magenta toner image by the developing device 23M. In the primary transfer portion T1M, the magenta toner image is transferred by the primary transfer device 24M onto the yellow toner image on the intermediate transfer belt 13 accurately in a superimposed manner.

After a predetermined time period has elapsed since the start of scanning the photosensitive member 21M with the light beam LM, the light scanning device 101C starts scanning the photosensitive member 21C with a light beam LC modulated in accordance with image information for cyan, to thereby form an electrostatic latent image on the photosensitive member 21C. The electrostatic latent image is developed with the cyan toner into a cyan toner image by the developing device 23C. In the primary transfer portion T1C, the cyan toner image is transferred by the primary transfer device 24C onto the magenta toner image on the intermediate transfer belt 13 accurately in a superimposed manner.

After a predetermined time period has elapsed since the start of scanning the photosensitive member 21C with the light beam LC, the light scanning device 101K starts scanning the photosensitive member 21K with a light beam LK modulated in accordance with image information for black, to thereby form an electrostatic latent image on the photosensitive member 21K. The electrostatic latent image is developed with the black toner into a black toner image by the developing device 23K. In the primary transfer portion T1K, the black toner image is transferred by the primary transfer device 24K onto the cyan toner image on the intermediate transfer belt 13 accurately in a superimposed manner.

In this manner, the four-color toner images are superimposed on the intermediate transfer belt 13. The recording medium S, which is conveyed from the sheet-feeding portion 1, 2, or 3, is conveyed to the secondary transfer portion T2 by the registration roller pair 12 in synchronization with the toner images on the intermediate transfer belt 13. In the secondary transfer portion T2, the four-color toner images, which are superimposed on the intermediate transfer belt 13, are secondarily transferred onto the recording medium S by the secondary transfer roller 40 in a collective manner.

The recording medium S having the toner images transferred thereonto is conveyed to the nip formed between the fixing roller 35A and the pressure roller 35B of the fixing device 35. The fixing device 35 fixes the toner images onto the recording medium S by heating and pressurizing the recording medium S. In this manner, the recording medium S having the color image formed thereon is fed to a delivery roller pair 37 by a conveyance roller pair 36, and is further delivered onto a delivery tray 38 arranged outside the apparatus.

When a duplex printing mode of forming images on both sides of the recording medium S is selected, the conveyance direction of the recording medium S, which is conveyed by the conveyance roller pair 36, is switched by a flapper 60, and thus the recording medium S is conveyed to a reverse conveyance route 58 by conveyance rollers 61. The recording medium S is temporarily conveyed to a reverse route 65 by a conveyance roller pair 62, a flapper 64, and a conveyance roller pair 63. Then, the conveyance roller pair 63 is reversely rotated, and the conveyance direction of the recording medium S is switched by the flapper 64, to thereby convey the recording medium S from the reverse route 65 to a duplex conveyance route 67. In this manner, front and back surfaces of the recording medium S are reversed. By a plurality of conveyance roller pairs 68, the recording medium S is again conveyed to the registration roller pair 12 from the duplex conveyance route 67 through the conveyance roller pair 11. A toner image is transferred onto the back surface of the recording medium S in the secondary transfer portion T2. The toner image is fixed onto the back surface of the recording medium S in the fixing device 35. In this manner, the recording medium S having the images formed on both the sides is delivered onto the delivery tray 38 by the delivery roller pair 37.

(Rotary Encoder)

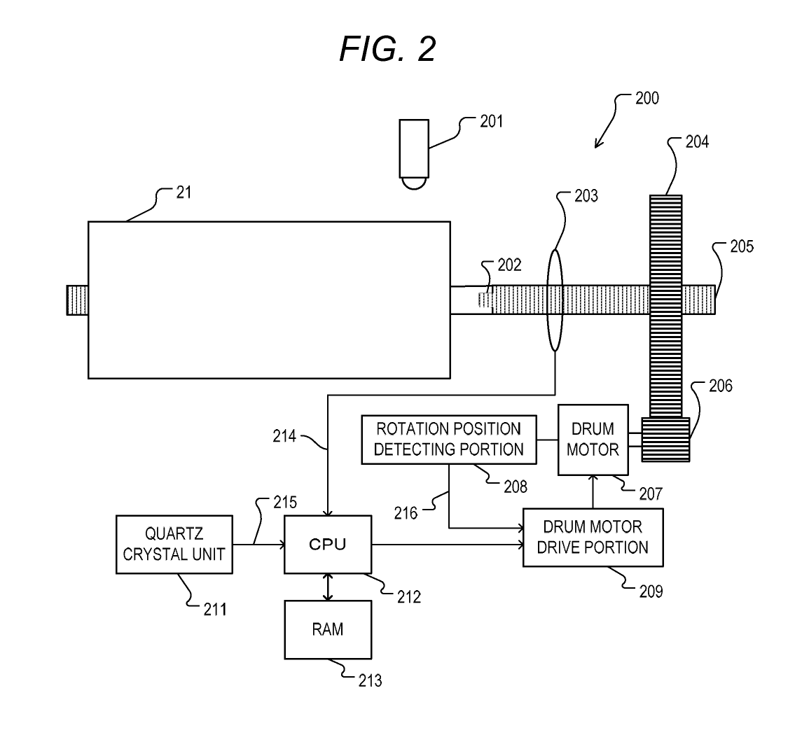

FIG. 2 is a diagram illustrating a drive mechanism 200 of the photosensitive member 21. The drive mechanisms 200 of the four image forming portions 20 are the same, and hence the suffixes Y, M, C, and K are omitted from reference symbols for description.

The photosensitive member 21 includes a coupling 202. The coupling 202 of the photosensitive member 21 is mechanically connected to a drum shaft (rotary shaft) 205. A speed reduction gear 204 and a rotary encoder (angular position detecting device) 203 are fixed to the drum shaft 205. The speed reduction gear 204 meshes with a motor shaft gear 206. The motor shaft gear 206 is fixed to a rotary shaft of a brushless DC motor (hereinafter referred to as “drum motor”) 207 serving as a drive source. Rotation of the drum motor 207 is transmitted to the drum shaft 205 through the motor shaft gear 206 and the speed reduction gear 204. With this, the photosensitive member 21 rotates integrally with the rotary encoder 203 due to a drive force of the drum motor 207.

A rotation position detecting portion 208 detects a rotation position of the drum motor 207 and outputs a rotation position signal 216 to a drum motor drive portion 209. Based on the rotation position signal 216, the drum motor drive portion 209 switches a phase of a phase current to be caused to flow through the drum motor 207 and adjusts a current amount of the phase current. In this manner, the drum motor drive portion 209 controls a rotation speed of the photosensitive member 21 through control of a rotation speed of the drum motor 207 based on a signal from a CPU (control unit) 212 and the rotation position signal 216.

The rotary encoder 203 functions as a surface movement distance detecting unit configured to detect a movement distance of a surface (hereinafter referred to as “surface movement distance”) of the rotating photosensitive member 21. The rotary encoder 203 outputs an encoder signal (angular position signal) 214 in accordance with an angular position of the rotating photosensitive member 21. The rotary encoder (second signal generating unit) 203 outputs the encoder signal (second signal) 214 to the CPU 212 in accordance with the rotation of the photosensitive member 21. The CPU 212 is electrically connected to each of the rotary encoder 203, the drum motor drive portion 209, a quartz crystal unit 211, and a RAM 213. The CPU 212 determines the surface movement distance of the photosensitive member 21 based on the encoder signal 214. Further, the CPU 212 counts a time interval of the encoder signal 214 based on a reference clock 215 input from the quartz crystal unit 211. The RAM (storage device) 213 stores date to be used for the computation. The CPU 212 reads out the data from the RAM 213 at the time of the computation.

Note that, a laser Doppler speedometer (second signal generating unit) 201 illustrated in FIG. 2 may be used instead of using the rotary encoder 203 to obtain the surface movement distance of the photosensitive member 21 based on a speed signal (second signal) received from the laser Doppler speedometer 201. Further, a plurality of marks provided on a surface of a region of the photosensitive member 21 excluding an image forming region along a rotation direction (sub-scanning direction C) of the photosensitive member 21 may be detected by an optical sensor (detecting unit) serving as the second signal generating unit and a detection signal (second signal) may be output from the optical sensor. A rotation amount (angular position), that is, the surface movement distance of the photosensitive member 21 may also be determined based on a detection result from the optical sensor. Alternatively, the rotation amount (angular position), that is, the surface movement distance of the photosensitive member 21 may also be determined based on the rotation position signal (second signal) 216 output from the rotation position detecting portion (second signal generating unit) 208. In this case, a relationship between a rotation amount of the drum motor 207 and the rotation amount of the photosensitive member 21 only needs to be determined in advance. A plurality of marks provided on a surface of a region of the intermediate transfer belt 13 excluding an image forming region along the rotation direction R of the intermediate transfer belt 13 may be detected by the optical sensor (detecting unit) serving as the second signal generating unit and the detection signal (second signal) may be output from the optical sensor. In this case, it is preferred that the intermediate transfer belt 13 be driven to rotate in association with the rotation of the photosensitive member 21 without slippage. A rotation amount of the intermediate transfer belt 13, that is, the surface movement distance of the photosensitive member 21 may also be determined based on the detection result from the optical sensor.

(Light Scanning Device)

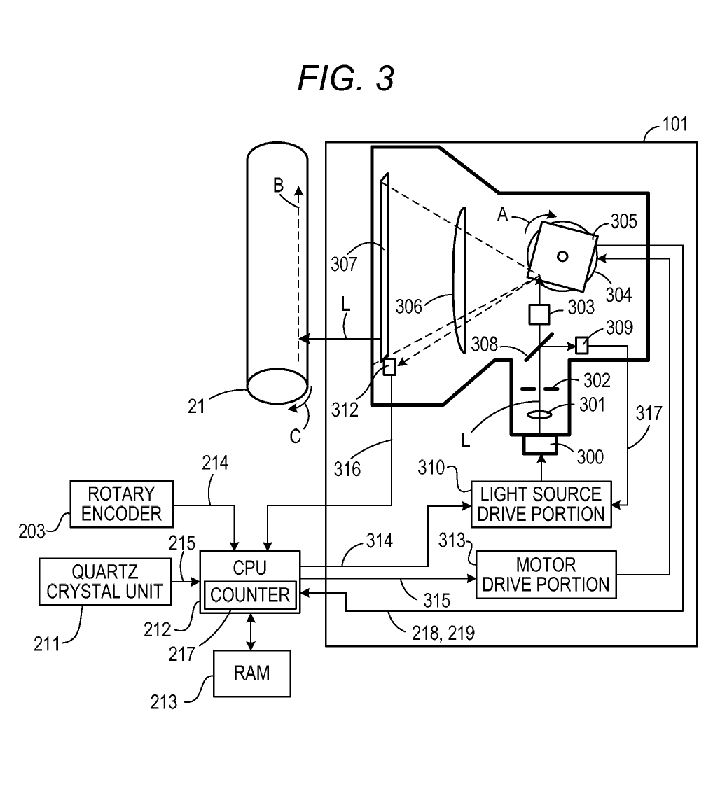

FIG. 3 is a block diagram illustrating a configuration of the light scanning device 101. The light scanning device 101 includes a semiconductor laser (hereinafter referred to as “light source”) 300, a rotary polygon mirror (deflecting member) 305 configured to deflect the light beam L from the light source 300, and a motor 304 configured to rotate the rotary polygon mirror 305. The light scanning device 101 includes an imaging lens (fθ lens) 306 configured to image the light beam deflected by the rotary polygon mirror 305 onto the photosensitive member 21. The light scanning device 101 further includes a light source drive portion 310 configured to drive the light source 300 and a motor drive portion 313 configured to drive the motor 304. The light scanning device 101 further includes a beam detector (hereinafter referred to as “BD”) 312 serving as a synchronous signal generating unit. The BD 312 is configured to output a synchronous signal (hereinafter referred to as “BD signal”) 316 in a direction indicated by the arrow B (hereinafter referred to as “main scanning direction B”) for maintaining a constant optical writing position on the surface of the photosensitive member 21 in the main scanning direction B. Assuming that the number of reflection surfaces of the rotary polygon mirror 305 is Z, the BD 312 outputs Z BD signals 316 per one revolution of the rotary polygon mirror 305. In other words, the BD 312 outputs one BD signal 316 at every one Z-th of the revolution of the rotary polygon mirror 305. Accordingly, the BD 312 functions as a rotation amount detecting device (first signal generating unit) configured to output the BD signal (first signal) indicating a rotation amount of the rotary polygon mirror 305.

In FIG. 3, the light beam L emitted from the light source 300 is converted by a collimator lens 301 into a substantially collimated light beam. A stop 302 confines the substantially collimated light beam L to shape the light beam L. The shaped light beam L enters a half-silvered mirror 308. A part of the light beam L reflected by the half-silvered mirror 308 enters a photodiode (hereinafter referred to as “PD”) 309. The PD 309 outputs a light intensity signal 317 in accordance with light intensity of the light beam L to the light source drive portion 310. The light source drive portion 310 performs feedback control of the light intensity of the light beam L output from the light source 300 based on the light intensity signal 317. The light source drive portion 310 further controls light emission of the light source 300 in accordance with a light emission control signal 314 from the CPU 212.

The light beam L, which passes through the half-silvered mirror 308, enters a cylindrical lens 303 having predetermined refractive power only in the sub-scanning direction. The light beam L, which enters the cylindrical lens 303, is condensed in a sub-scanning cross section while keeping a state of the substantially collimated light beam in a main scanning cross section. The light beam L, which is emitted from the cylindrical lens 303, is imaged into a linear shape on a reflection surface (deflection surface) of the rotary polygon mirror 305.

The rotary polygon mirror 305 is rotated by the motor 304 in a direction indicated by the arrow A (hereinafter referred to as “rotation direction A”). The light beam L is reflected, that is, deflected by the reflection surface of the rotating rotary polygon mirror 305. The light beam L, which is deflected by the rotary polygon mirror 305, passes through the imaging lens 306 having fθ characteristics, and is imaged on the surface (surface to be scanned) of the photosensitive member 21 through a reflection mirror 307. The light beam L scans the surface of the photosensitive member 21 at a constant speed in the main scanning direction B. The photosensitive member 21 is rotated in a direction indicated by the arrow C (hereinafter referred to as “sub-scanning direction C”), and hence the light beam L forms an electrostatic latent image on the surface of the photosensitive member 21 in accordance with image information.

The light beam L deflected by the rotary polygon mirror 305 further enters the BD 312. The BD 312 receives the light beam L, and then outputs the BD signal 316 to the CPU 212.

The CPU 212 is configured to control the motor 304 in accordance with the surface movement distance of the photosensitive member 21 so as to change the rotation speed of the rotary polygon mirror 305. The CPU 212 outputs an acceleration/deceleration signal 315 to the motor drive portion 313. The motor drive portion 313 drives the motor 304 in accordance with the acceleration/deceleration signal 315. The acceleration/deceleration signal 315 is a signal for controlling a rotation amount of the motor 304. The CPU 212 generates the acceleration/deceleration signal 315 based on the BD signal 316 from the BD 312 and the encoder signal 214 from the rotary encoder 203.

Note that, the CPU 212 is electrically connected to an FG sensor and a Hall IC arranged in the motor 304. The CPU 212 receives an FG signal 218 from the FG sensor and a signal 219 from the Hall IC.

(Image Forming Operation Control of CPU)

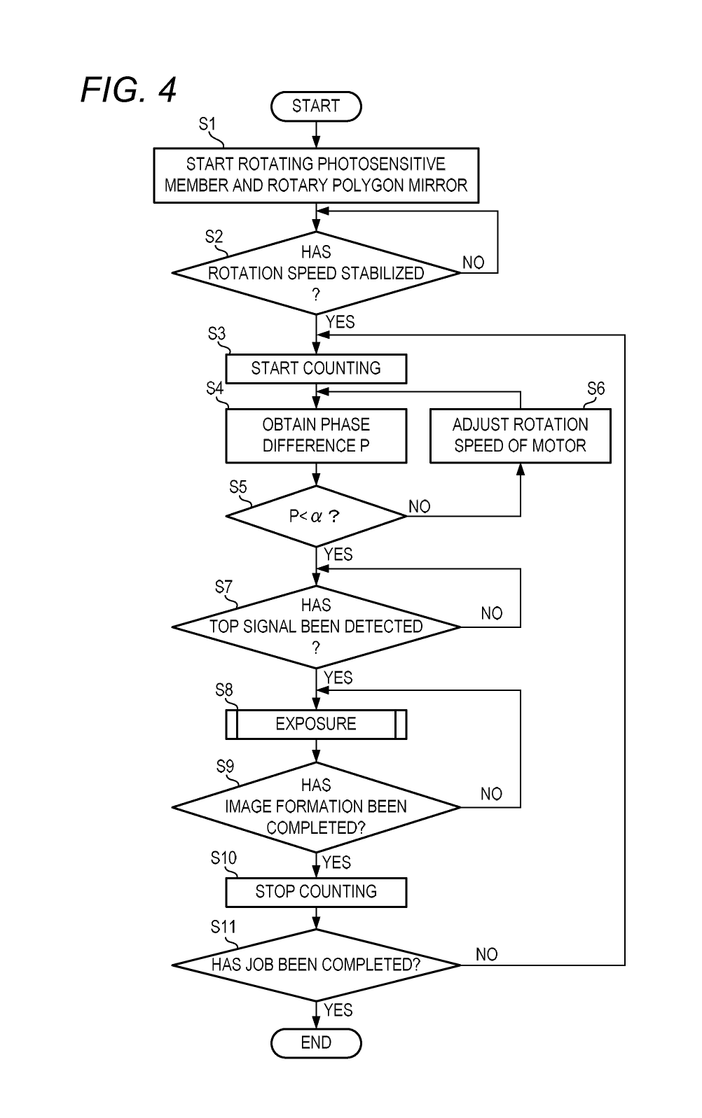

Next, with reference to FIG. 4, image forming operation control of the CPU 212 will be described. FIG. 4 is a flowchart illustrating image forming operation control of the CPU 212.

When the image forming apparatus 100 starts the image forming operation, the CPU 212 starts rotating the photosensitive member 21 and the rotary polygon mirror 305 by the drum motor 207 and the motor 304 (S1). The CPU 212 waits until the rotation speed of the photosensitive member 21 and the rotation speed of the rotary polygon mirror 305 are stabilized while monitoring the encoder signal 214 output from the rotary encoder 203 and the BD signal 316 output from the BD 312 (S2). The CPU 212 determines whether or not the photosensitive member 21 is being stably rotated with a rotation speed Vd for the time of image formation and the rotary polygon mirror 305 is being stably rotated with a rotation speed Vr for the time of image formation (S2). When determining that the photosensitive member 21 and the rotary polygon mirror 305 are being stably rotated (YES in Step S2), the CPU 212 uses a counter 217 to start count of a number X of BD signals 316 and count of a number Yrp of encoder signals 214 (S3). The number X of BD signals 316 and the number Yrp of encoder signals 214 are used in distance synchronizing exposure control described later.

The CPU 212 acquires a phase difference P between the encoder signal 214 output from the rotary encoder 203 and the BD signal 316 output from the BD 312 based on the reference clock 215 output from the quartz crystal unit 211 (S4). The CPU 212 adjusts the rotation speed of the motor 304 of the rotary polygon mirror 305 so that the phase difference P between the encoder signal 214 and the BD signal 316 falls within a predetermined range. To that end, the CPU 212 determines whether or not the phase difference P is smaller than a setting value α (P<α) (S5). The setting value α is set in advance as an allowable value of the phase difference P. When the phase difference P is not smaller than the setting value α (NO in Step S5), the CPU 212 adjusts the rotation speed of the motor 304 (S6). After that, the CPU 212 returns to Step S4, to acquire the phase difference P and determine whether or not the phase difference P is smaller than the setting value α (P<α) (S5). When the phase difference P is smaller than the setting value α (YES in Step S5), the CPU 212 determines that the phase difference P falls within the predetermined range, and advances to Step S7.

In Step S7, the CPU 212 determines whether or not an image writing timing control signal (hereinafter referred to as “TOP signal”) indicating a writing timing of a leading line (first line) of an image on a page-to-page basis, which is output from an image signal control portion (not shown), has been detected. When detecting the TOP signal (YES in Step S7), after waiting for the surface of the photosensitive member 21 to move by a distance from the leading scanning line of the image, the CPU 212 executes the exposure for forming the latent image in accordance with the image signal (S8). After that, the CPU 212 determines whether or not the image formation corresponding to one page has been completed (S9). When the image formation has not been completed (NO in Step S9), the CPU 212 returns to Step S8, to continue the exposure for latent image formation. When the image formation has been completed (YES in Step S9), the CPU 212 resets the counter 217 to finish the count (S10).

After that, the CPU 212 determines whether or not a job has been completed (S11). When the job has not been completed (NO in Step S11), the CPU 212 returns to Step S3, to execute the process of Steps S3 to S10 for the subsequent image formation. When the job is completed (YES in Step S11), the CPU 212 brings the image forming operation to an end.

(Distance Synchronizing Exposure control)

Next, control of the motor 304 to rotate the rotary polygon mirror 305 will be described. The CPU (comparator) 212 compares the BD signal (first signal) 316 with the encoder signal (second signal) 214, and changes the rotation speed of the motor 304 based on a comparison result thereof. Specifically, the CPU 212 generates the acceleration/deceleration signal 315 for controlling the motor 304 based on a phase difference between the BD signal 316 and the encoder signal 214 and a comparison between a period (first period) Tp of the BD signal 316 and a period (second period) Td of the encoder signal 214.

According to the embodiment, the rotation of the motor 304 is controlled (hereinafter referred to as “distance synchronizing exposure control”) so that the distance of the scanning line in the sub-scanning direction C formed on the photosensitive member 21 by the light beam L agrees with the surface movement distance of the photosensitive member 21. Even when an exposure position of the scanning line of the light beam L is temporarily displaced from a position (hereinafter referred to as “target position”) on the photosensitive member 21, which is originally required to be exposed, the motor 304 is subjected to the distance synchronizing exposure control so as to cause the exposure position of the scanning line of the light beam L to agree with the target position on the photosensitive member 21.

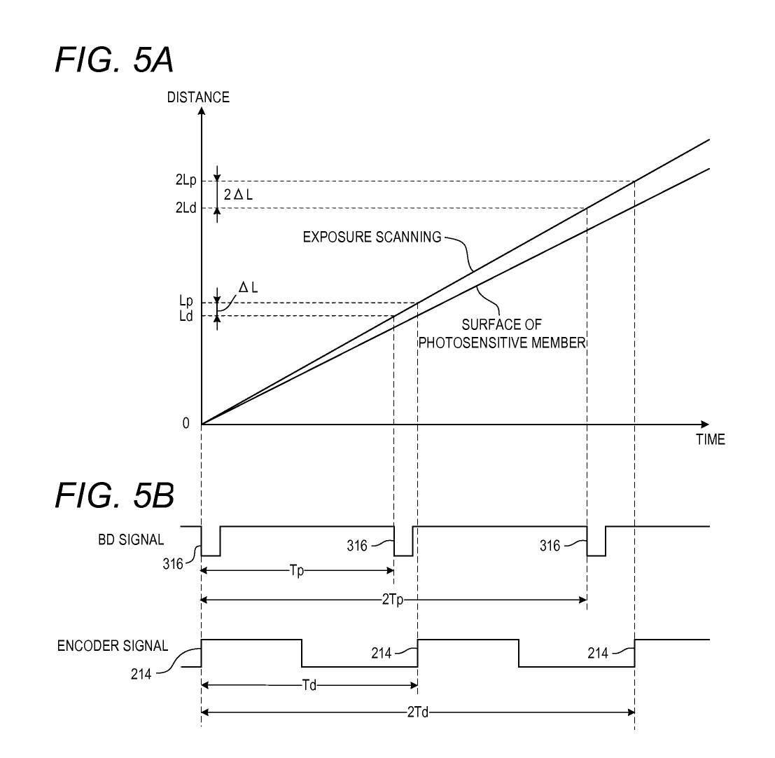

With reference to FIG. 5A and FIG. 5B, an operation for the distance synchronizing exposure control between the rotary polygon mirror 305 and the photosensitive member 21 will be described. FIG. 5A and FIG. 5B are explanatory diagrams of the distance synchronizing exposure control. FIG. 5A is a diagram illustrating a relationship among a scanning distance Lp by which an exposure scanning progresses, a surface movement distance Ld by which the surface of the photosensitive member 21 moves, and a time. FIG. 5B is a diagram illustrating a relationship between the BD signal 316 and the encoder signal 214.

FIG. 5A and FIG. 5B illustrate a case where the number (number Z of reflection surfaces) of BD signals 316 output per one revolution of the rotary polygon mirror 305 and the number of encoder signals 214 are set to the same number. In this case, one encoder signal 214 is output for one BD signal 316. When the phase difference P between the encoder signal 214 and the BD signal 316 falls within the predetermined range, the exposure is started in accordance with the TOP signal. When the period Td of the encoder signal 214 agrees with the period Tp of the BD signal 316, the exposure position of the scanning line of the light beam L agrees with the target position on the photosensitive member 21. However, for example, the period Td of the encoder signal 214 sometimes becomes longer than the period Tp of the BD signal 316 when the photosensitive member 21 slips against the intermediate transfer belt 13. In such a case, the exposure position of the scanning line of the light beam L is displaced from the target position on the photosensitive member 21. FIG. 5A and FIG. 5B illustrate a case where the period Td of the encoder signal 214 becomes longer than the period Tp of the BD signal 316.

As illustrated in FIG. 5A and FIG. 5B, a distance by which the surface of the photosensitive member 21 moves by the rotation of the photosensitive member 21 during the period Td of the encoder signal 214 (per interval between the encoder signals 214) is set as the surface movement distance Ld. In this case, due to such a setting that one encoder signal 214 is output for one BD signal 316, a distance by which the exposure scanning progresses in the sub-scanning direction C during the period Tp of the BD signal 316 (per interval between the BD signals 316) is set as the surface movement distance Ld. Then, a distance by which the exposure scanning progresses in the sub-scanning direction C by the rotation of the motor 304 during the period Td of the encoder signal 214 (per interval between the encoder signals 214) is set as the scanning distance Lp. A distance difference between the scanning distance Lp and the surface movement distance Ld is set as a distance difference ΔL (ΔL=Ld−Lp). When the scanning distance Lp agrees with the surface movement distance Ld (Ld=Lp), a distance difference does not occur (ΔL=0), and hence the exposure position of the scanning line of the light beam L agrees with the target position on the photosensitive member 21. Accordingly, when the rotation speed of the rotary polygon mirror 305 is controlled so that the scanning distance Lp agrees with the surface movement distance Ld (Lp=Ld, namely, ΔL=0), the exposure position of the light beam L agrees with the target position on the photosensitive member 21.

However, when the period Td of the encoder signal 214 becomes longer than the period Tp of the BD signal 316 as illustrated in FIG. 5B after the rotation speed of the photosensitive member 21 decreases relative to the rotation speed of the motor 304, the scanning distance Lp becomes larger than the surface movement distance Ld as illustrated in FIG. 5A. The scanning distance Lp caused by the rotation of the motor 304 during the time (period Td of the encoder signal 214) during which the photosensitive member 21 moves by the surface movement distance Ld becomes larger than the surface movement distance Ld. In FIG. 5A, Ld<Lp, and hence the distance difference ΔL (=Ld-Lp) is smaller than 0 (ΔL<0).

When the distance difference ΔL is smaller than 0 (ΔL<0), the CPU 212 outputs a deceleration signal to the motor drive portion 313 in order to decelerate the motor 304. On the other hand, when the distance difference ΔL is larger than 0 (ΔL>0), the CPU 212 outputs an acceleration signal to the motor drive portion 313 in order to accelerate the motor 304. By controlling the rotation speed of the motor 304, it is possible to cause a surface movement distance X×Ld of the photosensitive member 21 and a scanning distance X×Lp of the motor 304 to agree with each other, where X represents the number of BD signals 316. When the scanning distance X×Lp agrees with the surface movement distance X×Ld, the exposure position of the light beam L agrees with the target position on the photosensitive member 21. This is a basic concept of the distance synchronizing exposure control.

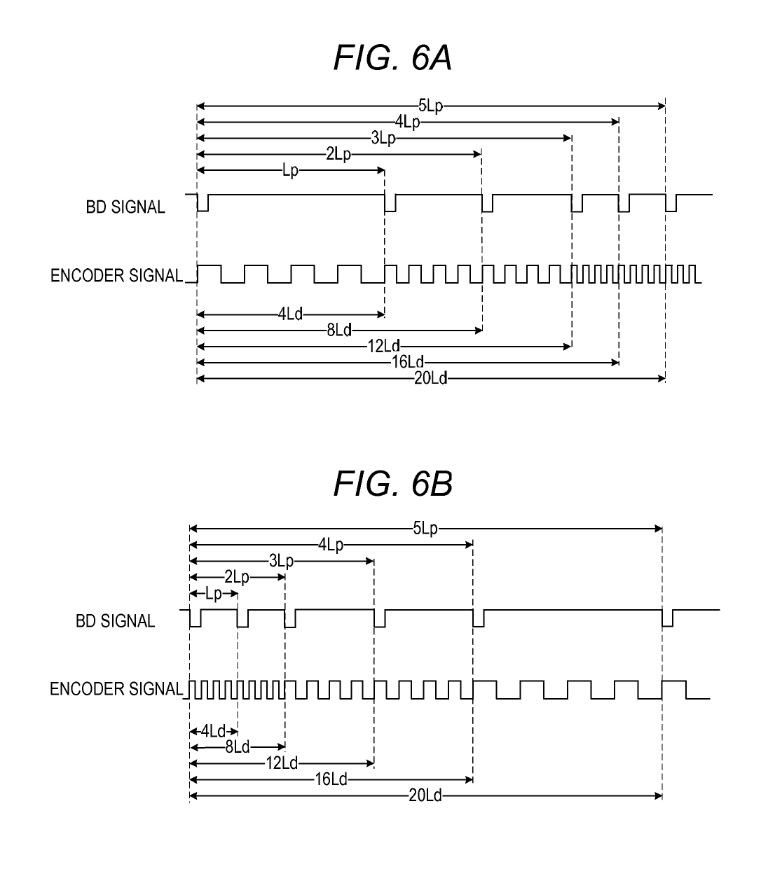

It is described above with reference to FIG. 5A and FIG. 5B that the scanning distance Lp is caused to agree with the surface movement distance Ld when one encoder signal 214 is output for one BD signal 316 (when the interval (period Tp) of the BD signal 316 agrees with the interval (period Td) of the encoder signal 214). Next, as illustrated in FIG. 6A and FIG. 6B, it will be described that the scanning distance Lp is caused to agree with the surface movement distance Ld when, for example, four encoder signals 214 are output for one BD signal 316.

A configuration in which four encoder signals 214 are output for one BD signal 316 will be described. A distance by which the exposure scanning progresses in the sub-scanning direction C by the rotation of the motor 304 during 4 periods 4×Td (per four intervals between the encoder signals 214) of the encoder signal 214 is set as the scanning distance Lp. The distance by which the surface of the photosensitive member 21 moves by the rotation of the photosensitive member 21 during the period Td of the encoder signal 214 (per interval between the encoder signals 214) is set as the surface movement distance Ld. When the scanning distance Lp agrees with the surface movement distance Ld, a relationship of Expression 1 is satisfied.

XLp=YLd (Expression 1)

X represents the number of BD signals 316 counted by the counter 217 after a shift is made to the distance synchronizing exposure control. Y represents the number of encoder signals 214 counted by the counter 217 after a shift is made to the distance synchronizing exposure control. X and Y satisfy a relationship of Y=4X. It suffices that the CPU 212 controls the rotation speed of the motor 304 so as to satisfy the relationship of Expression 1.

FIG. 6A and FIG. 6B are diagrams illustrating a relationship between the BD signal 316 and the encoder signal 214 in the distance synchronizing exposure control. FIG. 6A is a diagram illustrating the acceleration in the distance synchronizing exposure control. As illustrated in FIG. 6A, when the rotation speed of the photosensitive member 21 gradually accelerates, the CPU 212 outputs the acceleration signal to the motor drive portion 313 configured to drive the motor 304 in order to satisfy the relationship of Expression 1.

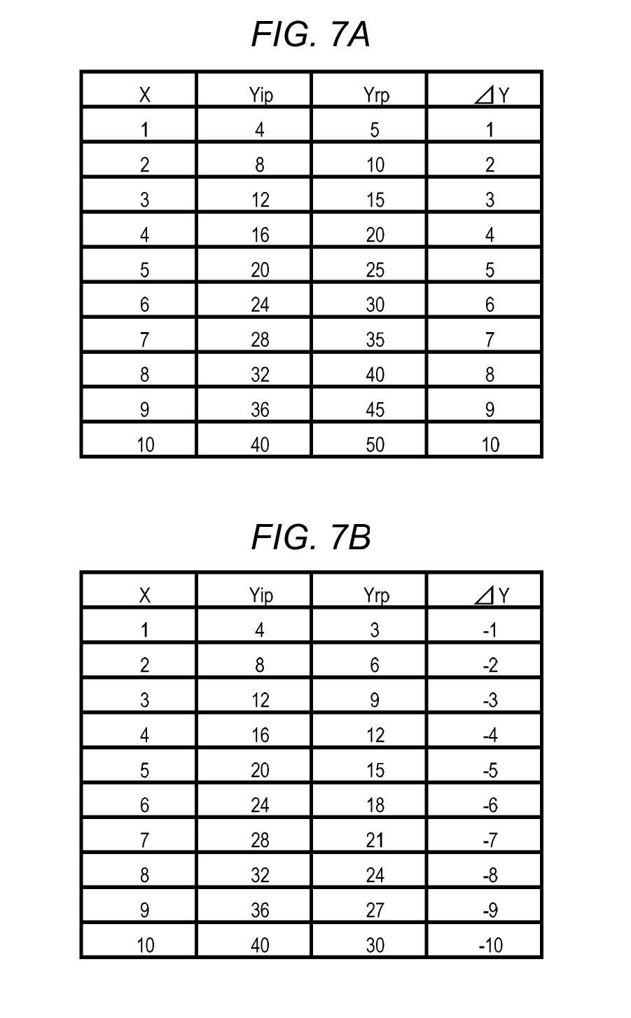

Now, with reference to FIG. 7A and FIG. 7B, a generation method for the acceleration signal for accelerating the motor 304 will be described. FIG. 7A and FIG. 7B are explanatory diagrams of a generation method for the control signal of the motor 304 at times of acceleration and deceleration of the photosensitive member 21. In FIG. 7A and FIG. 7B, an ideal number Yip (ideal position) of encoder signals 214 represents the number of encoder signals 214 corresponding to the number X of BD signals 316 when the rotation amount of the rotary polygon mirror 305 is following the rotation amount of the photosensitive member 21. The number X of BD signals 316 and the ideal number Yip of the encoder signal 214 satisfy the relationship of Expression 1. A number Yrp (real position) is set as the number of encoder signals 214 actually counted by the counter 217.

FIG. 7A is a diagram showing the generation method for the acceleration signal (control amount) for accelerating the motor 304 at the time of acceleration of the photosensitive member 21. In FIG. 6A, the photosensitive member 21 is accelerating, and hence in the case of the number X of BD signals of FIG. 7A, an acceleration amount corresponding to (Yrp−Yip)=ΔY is necessary to accelerate the motor 304. For example, when the acceleration amount corresponding to ΔY and the acceleration signal to be supplied to the motor 304 correspond to each other on a one-to-one basis, ΔY itself is the acceleration signal to be input to the motor 304.

FIG. 6B is a diagram illustrating the deceleration in the distance synchronizing exposure control. As illustrated in FIG. 6B, when the rotation speed of the photosensitive member 21 gradually decelerates, the CPU 212 outputs the deceleration signal to the motor drive portion 313 configured to drive the motor 304 in order to satisfy the relationship of Expression 1. FIG. 7B is a diagram showing a generation method for the deceleration signal (control amount) for decelerating the motor 304 at the time of deceleration of the photosensitive member 21. In FIG. 6B, the photosensitive member 21 is decelerating, and hence in the case of the number X of BD signals of FIG. 7B, a deceleration amount corresponding to (Yrp−Yip)=ΔY is necessary to decelerate the motor 304. For example, the deceleration amount corresponding to ΔY and the deceleration signal to be supplied to the motor 304 correspond to each other on a one-to-one basis, ΔY itself is the deceleration signal to be input to the motor 304.

The CPU 212 determines the control amount of the motor 304 based on the difference ΔY between the value Yip obtained by multiplying the number X of BD signals by a predetermined number (in the embodiment, 4) and the number Yrp of encoder signals 214. The CPU 212 controls a rotation amount of the motor 304 based on the control amount, so that the BD signal is synchronized with the encoder signal 214.

According to the embodiment, it is possible to control the rotation speed of the motor 304 to cause the surface movement distance of the photosensitive member 21 to agree with the distance by which the exposure scanning progresses in the sub-scanning direction C by the rotation of the motor 304, and to suitably expose the target position to the light beam L.

Note that, in the embodiment, the image forming apparatus 100 includes a plurality of photosensitive members 21 and a plurality of rotary polygon mirror 305 corresponding to the plurality of photosensitive members 21. However, the image forming apparatus 100 may include one photosensitive member 21 and one rotary polygon mirror 305. Alternatively, the image forming apparatus may include a plurality of photosensitive members 21 and one rotary polygon mirror 305 configured to deflect a plurality of light beams to the plurality of photosensitive members 21.

In the embodiment, the rotation speed Vr of the rotary polygon mirror 305 is changed in accordance with the rotation speed Vd of the photosensitive member 21. However, the rotation speed Vr of the rotary polygon mirror 305 may be changed in accordance with the fluctuation in a rotation speed Vb of the intermediate transfer belt (image bearing member) 13. In that case, by mounting a rotary encoder to a rotary shaft of the drive roller 13a configured to drive the intermediate transfer belt 13 to acquire the encoder signal, the motor 304 of the rotary polygon mirror 305 can be controlled in the same manner as in the above-mentioned embodiment. This produces the same effects as those of the above-mentioned embodiment.

In the embodiment, the BD 312 is used as the rotation amount detecting device (first signal generating unit) configured to detect the rotation amount of the rotary polygon mirror 305. However, the present invention is not limited thereto. The FG sensor configured to detect the rotation amount of the motor 304 may be used as the rotation amount detecting device (first signal generating unit) configured to detect the rotation amount of the rotary polygon mirror 305. The FG sensor is a pulse generating unit (frequency generating unit) located so as to be opposed to a magnet provided to a rotor of the motor 304, which is configured to generate an FG signal (pulse) in accordance with the rotation amount of the motor 304. The rotation amount of the motor 304, that is, the rotation amount of the rotary polygon mirror 305 may be detected based on the FG signal (first signal) 218 received from the FG sensor. Further, the Hall IC arranged in the motor 304 may be used as the rotation amount detecting device (first signal generating unit) configured to detect the rotation amount of the rotary polygon mirror 305. The Hall IC is a pulse generating unit located so as to be opposed to the magnet provided to the rotor of the motor 304, which is configured to generate a pulse (signal) in accordance with the rotation amount of the motor 304. The rotation amount of the motor 304, that is, the rotation amount of the rotary polygon mirror 305 may be detected based on the signal (first signal) 219 received from the Hall IC.

According to the embodiment, it is possible to synchronize the BD signal 316 with the encoder signal 214 by controlling the rotation amount of the motor 304 based on the BD signal 316 and the encoder signal 214. This allows the rotation speed of the rotary polygon mirror 305 to be controlled in accordance with a speed fluctuation of the photosensitive member 21, which can prevent banding and color misregistration to provide a high-quality image.

According to the embodiment, a suitable position (target position) on the surface of the photosensitive member 21 can be scanned with the light beam L.

### Second Embodiment

Now, a second embodiment of the present invention will be described. In the second embodiment, the same structures as those of the first embodiment are denoted by the same reference symbols, and descriptions thereof are omitted. Image forming operation control according to the second embodiment, which is conducted by the image forming apparatus 100, the rotary encoder 203, the light scanning device 101, and the CPU 212, is the same as that of the first embodiment, and hence a description thereof is omitted.

The second embodiment is different from the first embodiment in that the generation method for the control signal for controlling the rotation amount of the motor 304 of the rotary polygon mirror 305. Points different from those of the first embodiment are mainly described below.

It is described above in the first embodiment that the distance synchronizing exposure control is suitable for synchronous exposure control. The motor 304 and the photosensitive member 21 both constantly keep rotating, and hence even when the rotation amount of the motor 304 is controlled based on the distance difference ΔL at a given moment as in the first embodiment, the rotation amount of the photosensitive member 21 may change at the next moment. Therefore, the control of the rotation amount of the motor 304 may become unstable operation that does not converge. Therefore, the description of the second embodiment is directed to a method of stabilizing the control of the rotation amount of the motor 304 by computing, in consideration of the speed and the acceleration, the surface movement distance Ld of the photosensitive member 21 and the scanning distance Lp based on the rotation of the motor 304, to thereby predict a distance relationship at the next moment.

The photosensitive member 21 and the rotary polygon mirror 305 are both a rotary body, and hence the surface movement distance Ld and the scanning distance Lp can be expressed as follows, which is different from an exact expression, by using linear motion for the sake of simplicity.

Ld=Ld₀+Vdt+½Adt² (Expression 2)

Lp=Lp₀+Vpt+½Apt² (Expression 3)

In Expression 2 and Expression 3, Ld₀ represents an initial position of the photosensitive member 21, Vd represents the rotation speed of the photosensitive member 21, Ad represents a rotation acceleration of the photosensitive member 21, Lp₀ represents an initial position of the motor 304, Vp represents the rotation speed of the motor 304, Ap represents a rotation acceleration of the motor 304, and t represents a unit time.

With Expression 2 and Expression 3, the distance difference ΔL (=Ld−Lp) can be expressed as follows.

ΔL=(Ld₀−Lp₀)+(Vd−Vp)t+½(Ad−Ap)t² (Expression 4)

The distance difference ΔL can be expressed as follows with further simplified constant parts.

ΔL′=(Ld₀−Lp₀)G1+(Vd−Vp)G2+(Ad−Ap)G3 (Expression 5)

As expressed in Expression 5, in order to control a positional relationship between the photosensitive member 21 and the motor 304 at the next moment, the distance synchronizing exposure control can be carried out in consideration of the respective speeds and accelerations. Further, in this case, under various conditions, when values of constants G1, G2, and G3 within Expression 5 are extremely close to 0, each of the corresponding terms may be omitted. For example, when the constant G3 including a square term is approximately 0, it is possible to omit an acceleration term (Ad−Ap). In other words, a distance difference ΔL′ can be determined based on all of an initial position difference, a speed difference, and an acceleration difference or any one of the initial position difference, the speed difference, and the acceleration difference.

Note that, in the same manner as in the first embodiment, the obtained distance difference ΔL (ΔL′) is output as the acceleration/deceleration signal (control amount) 315 from the CPU 212 to the motor drive portion 313 configured to drive the motor 304. The motor drive portion 313 changes the rotation speed of the motor 304 based on the distance difference ΔL (ΔL′).

The CPU 212 determines the control amount by which the motor 304 is to be controlled based on at least one of the initial position difference, the speed difference, and the acceleration difference. The CPU 212 controls the rotation amount of the motor 304 based on the control amount, so that the BD signal 316 is synchronized with the encoder signal 214.

Incidentally, the description of the embodiment is directed to a case where rotational motion of the photosensitive member 21 and the motor 304 is replaced by the linear motion. However, the present invention is not limited thereto. For example, another method may be used to drive the moving distances of the photosensitive member 21 and the motor 304 to control the motor 304 so as to have a moving amount following a displacement amount thereof. Accordingly, a method of computing each moving amount at the next moment is not limited to what is described above, and may be derived from a relationship in the rotational motion or energy, or may be another predictive control.

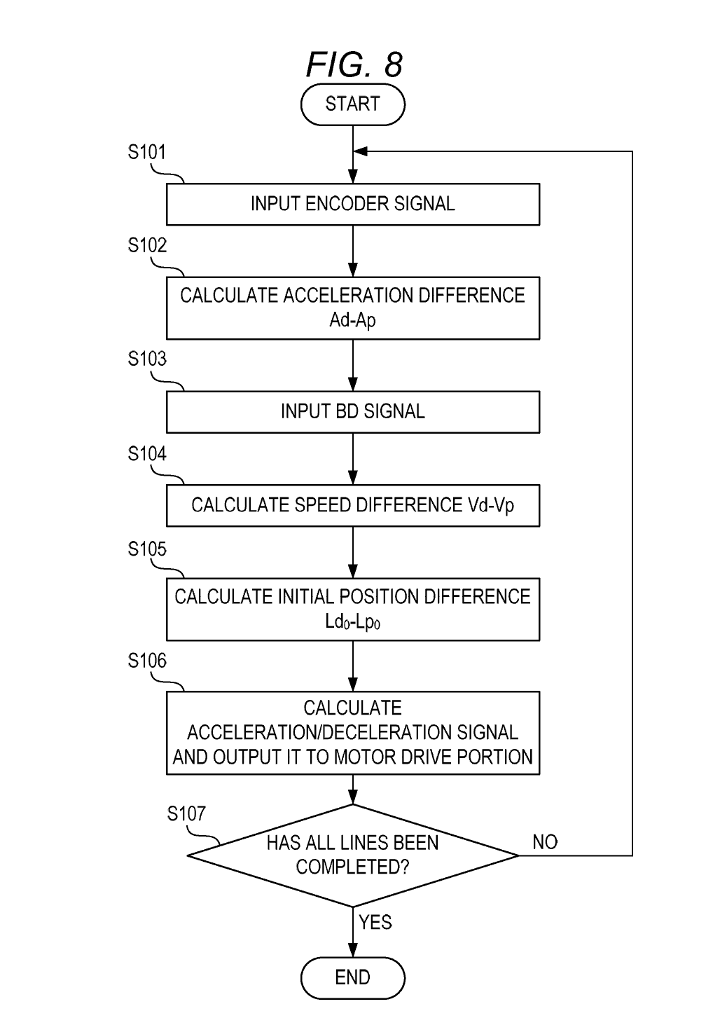

The image forming operation control of the CPU 212 according to the embodiment is the same as that of the first embodiment illustrated in FIG. 4, but the control in the exposure process of Step S8 is different from that of the first embodiment. Now, with reference to FIG. 8, points different from those of the first embodiment are mainly described below.

FIG. 8 is a flowchart illustrating an operation for generating an acceleration/deceleration signal for controlling the motor 304. After the exposure is started, the CPU 212 newly inputs the encoder signal 214 (S101), and calculates an acceleration difference Ad-Ap between the photosensitive member 21 and the motor 304 (S102). Subsequently, the CPU 212 newly inputs the BD signal 316 (S103), and calculates a speed difference Vd-Vp between the photosensitive member 21 and the motor 304 (S104). In addition, with the above-mentioned method, the CPU 212 calculates an initial position difference Ld₀−Lp₀ (S105). The CPU 212 calculates the acceleration/deceleration signal 315 by multiplying the initial position difference Ld₀−Lp₀ by the constant G1, multiplying the speed difference Vd-Vp by the constant G2, multiplying the acceleration difference Ad−Ap by the constant G3, and adding up the products, and outputs the acceleration/deceleration signal 315 to the motor drive portion 313 (S106). The CPU 212 determines whether or not the exposure of all the lines has been completed (S107). When the exposure of all the lines has not been completed (NO in Step S107), the CPU 212 returns to Step S101, and executes Steps S101 to S107. When the exposure of all the lines has been completed (YES in Step S107), the exposure is brought to an end. After that, the CPU 212 advances to Step S9 of FIG. 4, to determine whether or not the image formation has been completed.

According to the second embodiment, even when a fluctuation occurs in the rotation speed of the photosensitive member 21, the rotation speed of the motor 304 can be controlled optimally, to expose the target position on the surface of the photosensitive member 21 at an ideal scanning line interval. Further, according to the second embodiment, it is possible to stably execute the control of the rotation amount of the motor 304.

### Third Embodiment

Now, a third embodiment of the present invention will be described. In the third embodiment, the same structures as those of the first embodiment are denoted by the same reference symbols, and descriptions thereof are omitted. Image forming operation control according to the third embodiment, which is conducted by the image forming apparatus 100, the rotary encoder 203, the light scanning device 101, and the CPU 212, is the same as that of the first embodiment, and hence a description thereof is omitted.

The third embodiment is different from the first embodiment and the second embodiments in a method of acquiring the phase difference P between the encoder signal 214 and the BD signal 316 when a shift is made to the distance synchronizing exposure control. Different points are mainly described below. It is desired that the phase difference P be corrected because the phase difference P affects the writing timing of the image and accuracy of the color misregistration. In the third embodiment, the phase difference P acquired before the image forming operation is fed back to the control of the rotation amount of the motor 304.

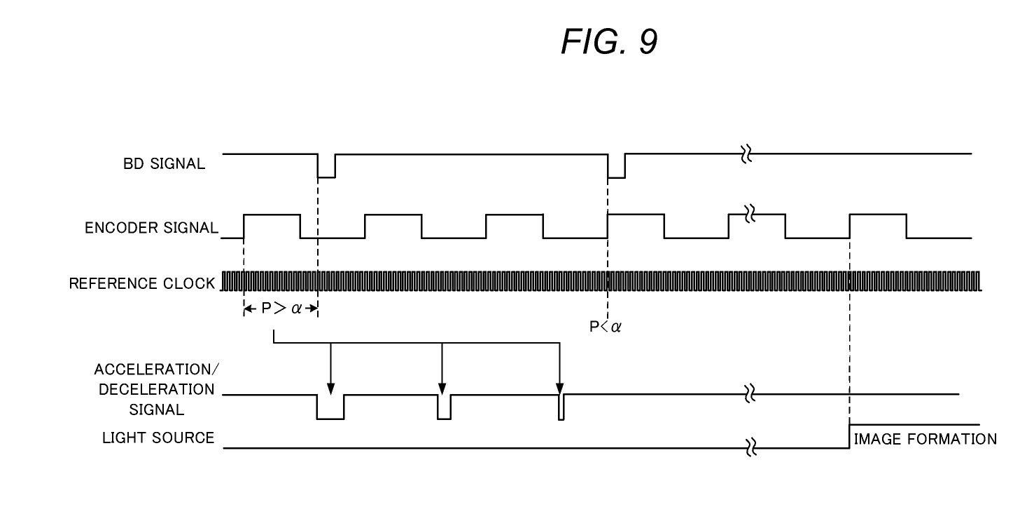

FIG. 9 is a timing chart of initial phase adjustment according to the third embodiment. As illustrated in FIG. 9, in a case where the phase difference P is larger than the setting value α when the shift is made to the distance synchronizing exposure control, the CPU 212 outputs the acceleration/deceleration signal (control amount) 315 to the motor drive portion 313, to finely adjust the rotation speed of the motor 304 so that the phase difference P becomes smaller than the setting value α. The CPU 212 stores the phase difference P calculated for each BD signal 316 in the RAM 213. The CPU 212 determines the acceleration/deceleration signal 315 based on the phase difference P stored in the RAM 213. However, the motor 304 can also be controlled at any control timing, with any control frequency, and by any control amount among the BD signals. For example, as illustrated in FIG. 9, control can be conducted so that a plurality of acceleration/deceleration signals 315 different in the pulse width are output by the time of the subsequent BD signal, to cause the phase difference P to gradually converge.

According to the third embodiment, the phase difference P between the encoder signal 214 and the BD signal 316 can be set to be smaller than the setting value a set in advance as the allowable value.

### Fourth Embodiment

Now, a fourth embodiment of the present invention will be described. In the fourth embodiment, the same structures as those of the first embodiment are denoted by the same reference symbols, and descriptions thereof are omitted. Image forming operation control according to the fourth embodiment, which is conducted by the image forming apparatus 100, the rotary encoder 203, the light scanning device 101, and the CPU 212, is the same as that of the first embodiment, and hence a description thereof is omitted.

The fourth embodiment is different from the first to third embodiments in a method of acquiring the phase difference P between the encoder signal 214 and the BD signal 316 when a shift is made to the distance synchronizing exposure control. Different points are mainly described below. In the fourth embodiment, the phase difference P acquired before the image forming operation is fed back to the light source 300.

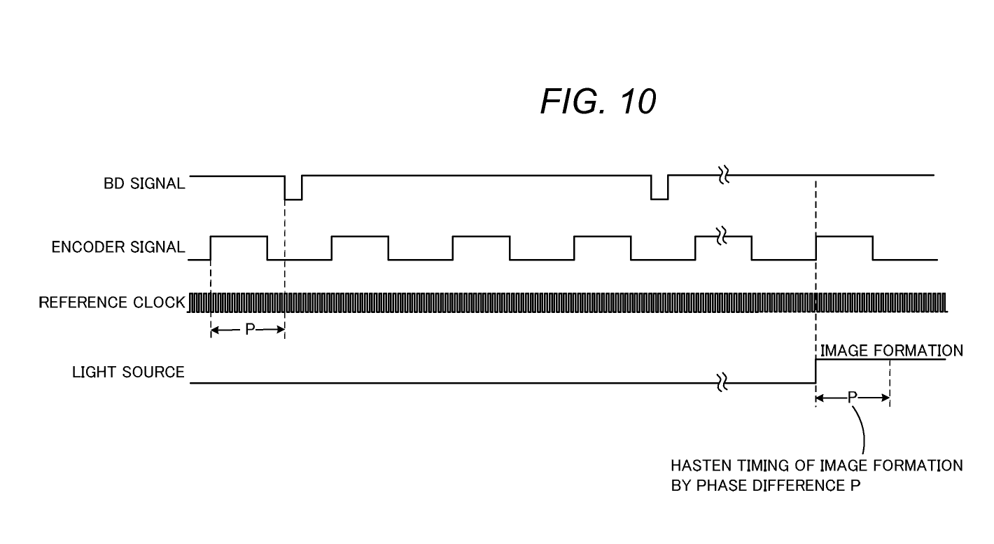

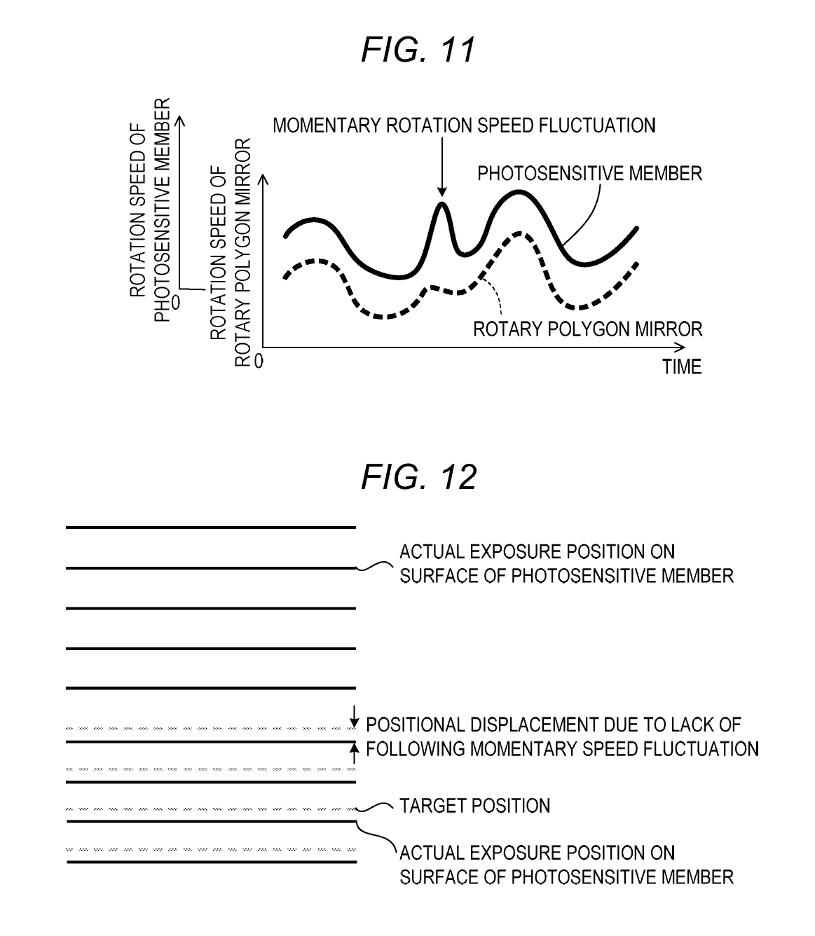

FIG. 10 is a timing chart of initial phase adjustment according to the fourth embodiment. The CPU 212 stores the phase difference P between the encoder signal 214 and the BD signal 316 acquired before the image forming operation in the RAM (storage device) 213. As illustrated in FIG. 10, the rotation amount of the motor 304 is controlled so as to synchronize the BD signal 316 with the encoder signal 214 in order to maintain the phase difference P acquired before the image forming operation. Based on the phase difference P, the CPU 212 controls a timing to start optical writing on the photosensitive member 21 with the light beam L emitted from the light source 300. In other words, it is possible to adjust an optical writing position on the photosensitive member 21 by shifting a light emission starting timing of the light source 300 by the phase difference P at a time of the image forming operation. However, the optical writing position on the photosensitive member 21 is also determined based on a relationship between the BD signal 316 and the light emission starting timing, and hence the phase difference P between the encoder signal 214 and the BD signal 316 is maintained.

For example, when the scanning is conducted with a multi-beam such as 4 beams, it is possible to finely adjust the optical writing position on the photosensitive member 21. In FIG. 10, it is possible to correct the optical writing position on the photosensitive member 21 by scanning the light beam L with the image data displaced by the phase difference P.

Incidentally, the descriptions of the above-mentioned embodiments are directed to such control as to cause the exposure position based on the rotary polygon mirror 305 to follow the position of the photosensitive member 21, but the present invention is not limited thereto. The position of the photosensitive member 21 may be controlled to follow the exposure position of the rotary polygon mirror 305, to cause the surface movement distance Ld of the photosensitive member 21 to agree with the scanning distance Lp.

Further, when the photosensitive member 21 is moved so as to follow the intermediate transfer belt 13 without slipping, a detecting unit configured to detect the moving distance of the intermediate transfer belt 13 may be provided to control the rotation amount of the rotary polygon mirror 305 based on a detection result from the detecting unit.

According to the first to fourth embodiments, even when the rotation speed of the photosensitive member fluctuates, it is possible to scan a suitable position on the surface of the photosensitive member with the light beam.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-095909, filed May 7, 2014, which is hereby incorporated by reference herein in its entirety.

What is claimed is:

1. An image forming apparatus, comprising:
a rotatable photosensitive member;
a light source configured to emit a light beam;
a rotary polygon mirror configured to deflect the light beam so that the light beam emitted from the light source scans a surface of the photosensitive member;
a motor configured to rotate the rotary polygon mirror;
a first signal generating unit configured to detect a rotation amount of the rotary polygon mirror to generate a first signal; and
a second signal generating unit configured to detect a rotation amount of the photosensitive member to generate a second signal,
wherein a rotation amount of the motor is controlled based on the first signal and the second signal so that the first signal is synchronized with the second signal.

2. An image forming apparatus according to claim 1, wherein the second signal generating unit comprises a rotary encoder fixed to a rotary shaft of the photosensitive member.

3. An image forming apparatus according to claim 1, wherein the second signal generating unit comprises a detecting unit configured to detect a plurality of marks provided on the photosensitive member along a rotation direction of the photosensitive member.

4. An image forming apparatus according to claim 1, wherein the first signal generating unit comprises a synchronous signal generating unit configured to receive the light beam to generate, as the first signal, a synchronous signal for optical writing on the surface of the photosensitive member with the light beam.

5. An image forming apparatus according to claim 1, wherein the first signal generating unit comprises a pulse generating unit configured to generate a pulse as the first signal in accordance with the rotation amount of the motor, the pulse generating unit being disposed opposite to a magnet provided on a rotor of the motor.

6. An image forming apparatus according to claim 1, further comprising a storage device configured to store a phase difference between the first signal and the second signal,
wherein a timing to start optical writing on the surface of the photosensitive member with the light beam emitted from the light source is controlled based on the phase difference.

7. An image forming apparatus according to claim 1, further comprising a storage device configured to store a phase difference between the first signal and the second signal,
wherein the rotation amount of the motor is controlled based on the phase difference.

8. An image forming apparatus according to claim 1, wherein the rotation amount of the motor is controlled based on a difference between a value obtained by multiplying a number of first signals by a predetermined number and a number of second signals so that the first signal is synchronized with the second signal.

9. An image forming apparatus according to claim 1, wherein the rotation amount of the motor is controlled based on at least one of an initial position difference, a speed difference, and an acceleration difference which are obtained from the first signal and the second signal so that the first signal is synchronized with the second signal.

10. An image forming apparatus according to claim 1, comprising:
a plurality of photosensitive members; and
a plurality of rotary polygon mirrors provided correspondingly to the plurality of photosensitive members.

11. An image forming apparatus, comprising:
a rotatable photosensitive member;
a light source configured to emit a light beam;
a rotary polygon mirror configured to deflect the light beam so that the light beam emitted from the light source scans a surface of the photosensitive member;
a motor configured to rotate the rotary polygon mirror;
a first signal generating unit configured to detect a rotation amount of the rotary polygon mirror to generate a first signal;
an intermediate transfer member to which a toner image is transferred from the photosensitive member and from which the transferred toner image is transferred onto a recording medium; and
a second signal generating unit configured to detect a rotation amount of the intermediate transfer member to generate a second signal,
wherein a rotation amount of the motor is controlled based on the first signal and the second signal so that the first signal is synchronized with the second signal.

12. An image forming apparatus according to claim 11, wherein the second signal generating unit comprises a rotary encoder fixed to a rotary shaft of the intermediate transfer member.

13. An image forming apparatus according to claim 11, wherein the second signal generating unit comprises a detecting unit configured to detect a plurality of marks provided on the intermediate transfer member along a rotation direction of the intermediate transfer member.

14. An image forming apparatus according to claim 11, wherein the first signal generating unit comprises a synchronous signal generating unit configured to receive the light beam to generate, as the first signal, a synchronous signal for optical writing on the surface of the photosensitive member with the light beam.

15. An image forming apparatus according to claim 11, wherein the first signal generating unit comprises a pulse generating unit configured to generate a pulse as the first signal in accordance with the rotation amount of the motor, the pulse generating unit being disposed opposite to a magnet provided on a rotor of the motor.

16. An image forming apparatus according to claim 11, further comprising a storage device configured to store a phase difference between the first signal and the second signal,
wherein a timing to start optical writing on the surface of the photosensitive member with the light beam emitted from the light source is controlled based on the phase difference.

17. An image forming apparatus according to claim 11, further comprising a storage device configured to store a phase difference between the first signal and the second signal,
wherein the rotation amount of the motor is controlled based on the phase difference.

18. An image forming apparatus according to claim 11, wherein the rotation amount of the motor is controlled based on a difference between a value obtained by multiplying a number of first signals by a predetermined number and a number of second signals so that the first signal is synchronized with the second signal.

19. An image forming apparatus according to claim 11, wherein the rotation amount of the motor is controlled based on at least one of an initial position difference, a speed difference, and an acceleration difference which are obtained from the first signal and the second signal so that the first signal is synchronized with the second signal.

20. An image forming apparatus according to claim 11, comprising:
a plurality of photosensitive members; and
a plurality of rotary polygon mirrors provided correspondingly to the plurality of photosensitive members.
